(19) United States
(12) Patent Application Publication
(10) Pub. No.: US 2007/0213089 A1
(43) Pub. Date: Sep. 13, 2007

(54) Mobile communication terminal device, communication program, and communication method

(75) Inventor: Hidekazu Ito, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/522,431

(22) Filed: Sep. 18, 2006

(30) Foreign Application Priority Data
Mar. 9, 2006 (JP) 2006-064571

(51) Int. Cl. H04M 1/00

(52) U.S. Cl. 455/550.1

(57) ABSTRACT

A mobile communication terminal device that allows a third party to acquire position information, computed based on received GPS information, without requiring any operation on the side of the user of the mobile communication terminal device equipped with a GPS receiver. The mobile communication terminal device, which is connected to a network via radio, includes: a unit for receiving position information transmit request mail at a special address provided exclusively to accept a position information transmit request; a unit for receiving GPS information from a GPS satellite in response to the received position information transmit request mail; a unit for acquiring current position information based on the received GPS information; and a unit for transmitting the acquired position information as return mail to a predesignated mail address.

### BACKGROUND OF THE INVENTION

1. Field of the Invention

The present invention relates to a mobile communication terminal device, such as a portable telephone, and a communication program and communication method for use in a communication system in which mobile communication terminal devices, etc. are connected over a network.

2. Description of the Related Art

In recent years, mobile communication terminal devices exemplified by portable telephones have been spreading widely and, with their widespread use, dramatic technological developments have been made. Among others, portable telephones equipped with GPS (Global Positioning System) receivers have been introduced into the market. At present, four satellites in each of six orbit planes (a total of 24 satellites) are circling the earth. Each GPS satellite is equipped with a high-precision clock, and transmits a navigation message (GPS information) containing its identification number, time of transmission, orbital position, etc. A GPS receiver needs to receive navigation messages from at least four GPS satellites in order to measure the latitude, longitude, altitude, and time.

User position information, that the user of a portable telephone equipped with a GPS receiver obtains by operating the telephone, can be transmitted to a third party only when the user operates the telephone for transmission. Accordingly, there arises the problem that if, for some reason, the user of the GPS receiver-equipped portable telephone becomes unable to perform operations to receive GPS information and transmit the obtained position information, the third party cannot acquire the user's position information.

Japanese Unexamined Patent Publication No. H09-107418, a prior art document related to the present invention, discloses a mobile radio telephone terminal which, when the user of the terminal is unable to initiate a call for some reason, automatically makes a call to a predetermined party in a reliable manner and allows the terminal to be remotely operated as needed from the called party. On the other hand, Japanese Unexamined Patent Publication No. 2003-224886 discloses a communication system and a mobile communication terminal device wherein provisions are made to prevent unauthorized use by a third party in the event of the loss of the mobile communication terminal device and to assist the user in finding the lost mobile communication terminal device as quickly as possible. Further, Japanese Unexamined Patent Publication No. 2005-244494 discloses a mobile communication terminal device that can be manipulated by a simple operation from a remote location to take a picture and transmit the picture to the remote location.

### SUMMARY OF THE INVENTION

The present invention has been devised in view of the above problem, and an object of the invention is to provide a mobile communication terminal device, a communication program, and a communication method that allow a third party to acquire position information computed based on received GPS information, without requiring any operation on the side of the user of the mobile communication terminal device equipped with a GPS receiver.

To achieve the above object, according to the present invention, there is provided a mobile communication terminal device which is connected to a network via radio, comprising: a special mail receiving unit for receiving position information transmit request mail at a special address provided exclusively to accept a position information transmit request; a GPS information receiving unit for receiving GPS information from a GPS satellite in response to the position information transmit request mail received by the special mail receiving unit; a position information acquiring unit for acquiring current position information based on the GPS information received by the GPS information receiving unit; and a return mail transmitting unit for transmitting the position information acquired by the position information acquiring unit as return mail to a predesignated mail address.

In one preferred mode, the mobile communication terminal device further comprises a unit for maintaining the special mail receiving unit in an operating condition even when a power supply circuit in the mobile communication terminal device is OFF.

Also preferably, the mobile communication terminal device further comprises a unit for automatically activating the power supply circuit when the special mail receiving unit has received the position information transmit request mail while the power supply circuit in the mobile communication terminal device is OFF.

According to the present invention, there is also provided a communication program for use in a communication system in which at least one terminal and one mobile communication terminal device connected via radio are connected to each other over a network, wherein the communication program causes the mobile communication terminal device to carry out the functions of: a special mail receiving unit for receiving position information transmit request mail at a special address provided exclusively to accept a position information transmit request; a GPS information receiving unit for receiving GPS information from a GPS satellite in response to the position information transmit request mail received by the special mail receiving unit; a position information acquiring unit for acquiring current position information based on the GPS information received by the GPS information receiving unit; and a return mail transmitting unit for transmitting the position information acquired by the position information acquiring unit as return mail to a predesignated mail address, and also causes the one terminal to carry out the functions of: a special mail transmitting unit for transmitting the position information transmit request mail to the special address of the mobile communication terminal device; and a return mail receiving unit for receiving the return mail from the mobile communication terminal device.

According to the present invention, there is also provided a communication method for use in a communication system in which at least one terminal and one mobile communication terminal device connected via radio are connected to each other over a network, the communication method comprising: causing the one terminal to transmit position information transmit request mail to a special address provided in the mobile communication terminal device exclusively to accept a position information transmit request; causing the mobile communication terminal device to receive the position information transmit request mail via the special address; causing the mobile communication terminal device to receive GPS information from a GPS satellite in response to the received position information transmit request mail; causing the mobile communication terminal device to acquire current position information based on the received GPS information; causing the mobile communication terminal device to transmit the acquired position information as return mail to a predesignated mail address; and causing the one terminal to receive the return mail.

According to the present invention, a third party can acquire the position information computed based on the received GPS information, without requiring any operation on the side of the user of the GPS receiver-equipped mobile communication terminal device. Even when the power supply in the mobile communication terminal device is OFF, the third party can acquire the position information.

### BRIEF DESCRIPTION OF THE DRAWINGS

Further features and advantages of the present invention will be apparent from the following description with reference to the accompanying drawings, in which:

FIG. 1 is a diagram showing the system configuration according to an embodiment of the present invention;

FIG. 2 is a diagram showing the internal configuration of a portable telephone 10 shown in FIG. 1;

FIG. 3 is a flowchart showing a sequence of processing operations according to the embodiment of the present invention; and

FIG. 4 is a diagram showing a table defining a mapping between a position information requesting address and a position information destination address.

### DESCRIPTION OF THE PREFERRED EMBODIMENTS

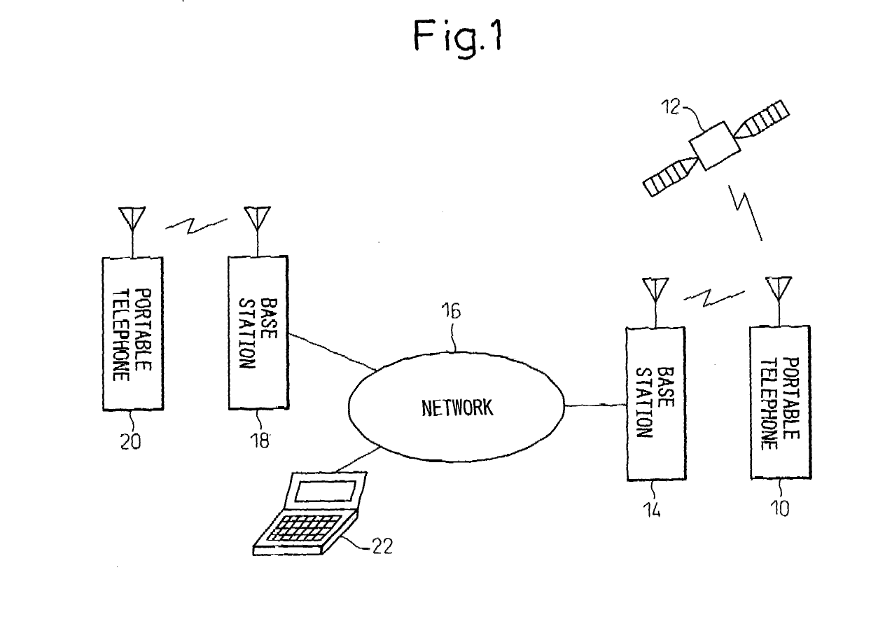

An embodiment of the present invention will be described below with reference to the accompanying drawings. FIG. 1 is a diagram showing the system configuration according to the embodiment of the present invention. A portable telephone 10 is equipped with a GPS receiving function and is capable of obtaining GPS information (navigation messages) by receiving radiowaves from GPS satellites 12. The portable telephone 10 communicates via a radio channel (radiowave) with a base station 14 serving the area of its current location, and is connected to the Internet 16 via the base station 14.

To the Internet 16 are also connected another portable telephone 20, via a different base station 18, and a personal computer 22. These terminals connected to the Internet 16, i.e., the portable telephone 10, the portable telephone 20, and the personal computer 22, exchange electronic mail between them. Here, the portable telephone 20 need not be equipped with a GPS receiving function.

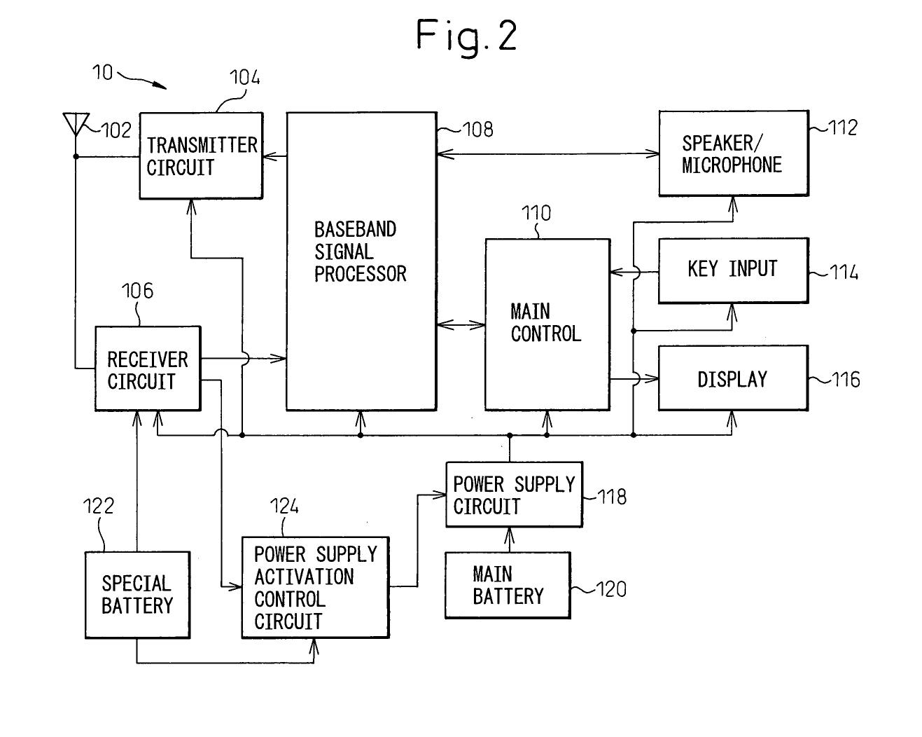

FIG. 2 is a diagram showing the internal configuration of the portable telephone 10 shown in FIG. 1. In the figure, reference numeral 102 is an antenna, 104 is a transmitter circuit, 106 is a receiver circuit, 108 is a baseband signal processing section, 110 is a main control section, 112 is a speaker/microphone section, 114 is a key input section, 116 is a display section, 118 is a power supply circuit, 120 is a main battery, 122 is a special battery, and 124 is a power supply activation control circuit.

Here, the baseband signal processing section 108 performs modulation, demodulation, radio communication control, speech processing, multimedia interface processing, etc. The main control section 110 performs communication protocol handling, application processing, etc. The special battery 122 and the power supply activation control circuit 124 are specifically provided to implement the present invention and, as will be described later, enable special electronic mail to be received and the power supply to be automatically activated, even when the power supply of the portable telephone 10 is OFF.

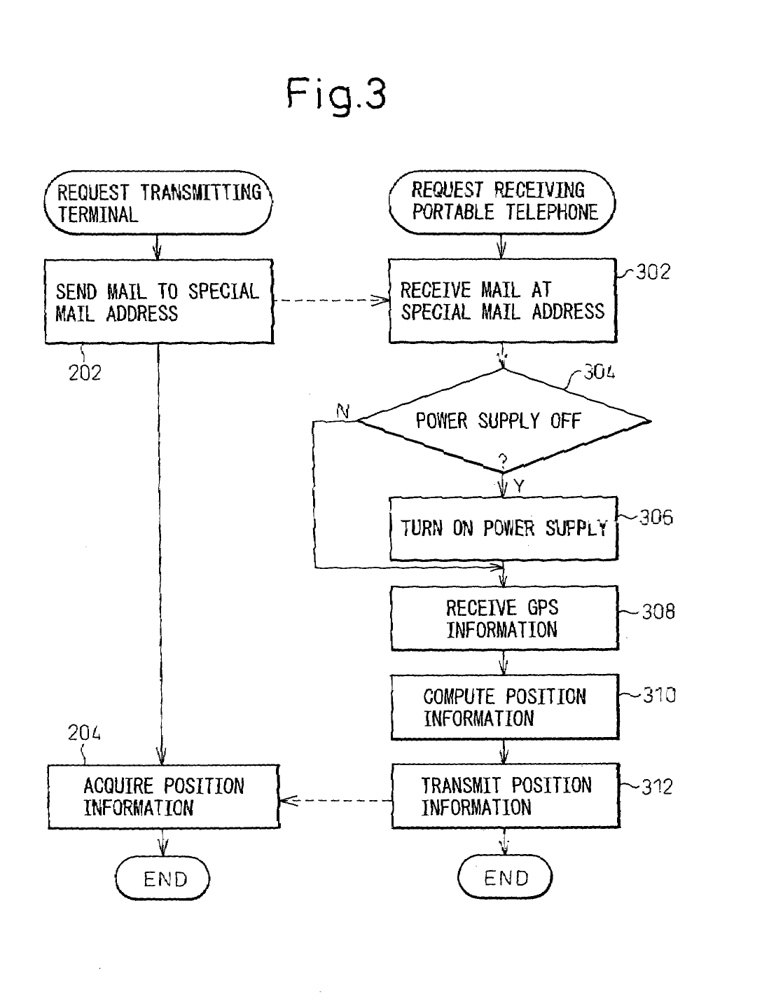

FIG. 3 is a flowchart showing a sequence of processing operations according to the embodiment of the present invention. It is assumed here that the GPS receiver-equipped portable telephone 10 of FIG. 2 has, in addition to its usual electronic mail address, a special electronic mail address allocated by the communication provider or the like and exclusively used to accept a position information transmit request. It is further assumed that electronic mail addresses permitted to send electronic mail to that special electronic mail address are also managed by the communication provider or the like.

For example, assume that the portable telephone 20 and the personal computer 22 in FIG. 2 are permitted to send a position information transmit request in the form of special electronic mail to the GPS receiver-equipped portable telephone 10, and are registered accordingly. First, the user of the portable telephone 20 or the personal computer 22 (position information transmit request transmitting terminal) sends the position information transmission requesting special electronic mail to the position information transmit request accepting special electronic mail address of the GPS receiver-equipped portable telephone 10 (position information transmit request receiving terminal) (step 202). There is no need to include a text massage in the electronic mail.

Then, the GPS receiver-equipped portable telephone 10 receives the position information transmission requesting special electronic mail (step 302). In the portable telephone 10, even when the power supply circuit 118 is OFF, the necessary portion of the receiver circuit 106 is maintained in an active condition by the special battery 122 so that the special electronic mail can be received.

When the special electronic mail is received while the power supply of the portable telephone 10 is OFF, the receiver circuit 106 sends a signal notifying the power supply activation control circuit 124 of the reception (step 304). Thereupon, the power supply activation control circuit 124 turns on the power supply of the portable telephone 10 by controlling the power supply circuit 118 (step 306).

Next, the portable telephone 10 obtains GPS information (navigation message) from each of the four GPS satellites 12 (step 308). Then, the portable telephone 10 computes the current position information (latitude and longitude) based on the obtained GPS information (step 310). Alternatively, the portable telephone 10 may transmit the GPS information to a position information center (reference station) connected to the Internet and may request it to compute the position information and return the results.

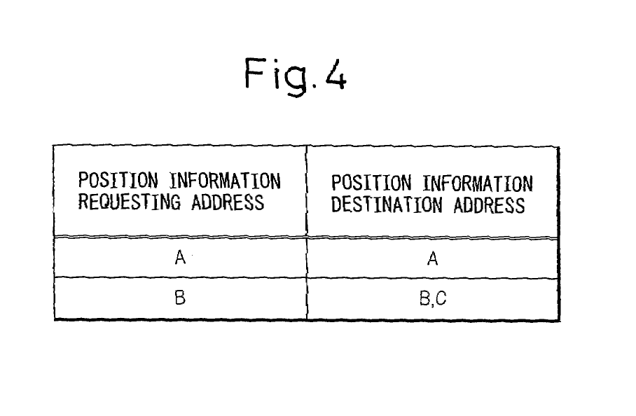

Finally, the portable telephone 10 transmits its position information to the predesignated electronic mail address (step 312). For this purpose, the portable telephone 10 maintains a mapping table which defines a mapping between the position information requesting address and the position information destination address, as shown in FIG. 4. As a general rule, the position information destination address includes the position information requesting address.

Then, the position information transmission requesting portable telephone 20 or personal computer 22 receives the position information via electronic mail, thus allowing the user of the receiving terminal to know the location of the GPS receiver-equipped portable telephone 10.

Generally, the portable telephone has the function of indicating the remaining capacity of the battery on the display section 116, but the portable telephone 10 of the present embodiment is constructed to produce an indication that the remaining battery capacity is zero when the state of charge of the battery has decreased to a point where the remaining capacity of the battery is just sufficient to perform the operations for receiving the GPS information, acquiring the position information, and transmitting the return mail when the power supply circuit 118 is automatically activated. This ensures that the transmission of the position information is effected without fail when the need arises.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A mobile communication terminal device which is connected to a network via radio, comprising:
a special mail receiving unit for receiving position information transmit request mail at a special address provided exclusively to accept a position information transmit request;
a GPS information receiving unit for receiving GPS information from a GPS satellite in response to said position information transmit request mail received by said special mail receiving unit;
a position information acquiring unit for acquiring current position information based on the GPS information received by said GPS information receiving unit; and
a return mail transmitting unit for transmitting the position information acquired by said position information acquiring unit as return mail to a predesignated mail address.

2. A mobile communication terminal device as claimed in claim 1, further comprising a unit for maintaining said special mail receiving unit in an operating condition even when a power supply circuit in said mobile communication terminal device is OFF.

3. A mobile communication terminal device as claimed in claim 2, further comprising a unit for automatically activating said power supply circuit when said special mail receiving unit has received said position information transmit request mail while said power supply circuit in said mobile communication terminal device is OFF.

4. A mobile communication terminal device as claimed in claim 3, wherein an indication that remaining battery capacity is zero is produced, leaving battery capacity just sufficient to operate said GPS information receiving unit, said position information acquiring unit, and said return mail transmitting unit when said power supply circuit is automatically activated.

5. A communication system in which at least one terminal and one mobile communication terminal device connected via radio are connected to each other over a network, wherein
said mobile communication terminal device comprises:
a special mail receiving unit for receiving position information transmit request mail at a special address provided exclusively to accept a position information transmit request;
a GPS information receiving unit for receiving GPS information from a GPS satellite in response to said position information transmit request mail received by said special mail receiving unit;
a position information acquiring unit for acquiring current position information based on the GPS information received by said GPS information receiving unit; and
a return mail transmitting unit for transmitting the position information acquired by said position information acquiring unit as return mail to a predesignated mail address, and
said one terminal comprises:
a special mail transmitting unit for transmitting said position information transmit request mail to said special address of said mobile communication terminal device; and
a return mail receiving unit for receiving said return mail from said mobile communication terminal device.

6. For use in a communication system, in which at least one terminal and one mobile communication terminal device connected via radio are connected to each other over a network, a communication program for causing said mobile communication terminal device to carry out the functions of:
a special mail receiving unit for receiving position information transmit request mail at a special address provided exclusively to accept a position information transmit request;
a GPS information receiving unit for receiving GPS information from a GPS satellite in response to said position information transmit request mail received by said special mail receiving unit;
a position information acquiring unit for acquiring current position information based on the GPS information received by said GPS information receiving unit; and
a return mail transmitting unit for transmitting the position information acquired by said position information acquiring unit as return mail to a predesignated mail address, and
causing said one terminal to carry out the functions of:
a special mail transmitting unit for transmitting said position information transmit request mail to said special address of said mobile communication terminal device; and
a return mail receiving unit for receiving said return mail from said mobile communication terminal device.

7. A communication method for use in a communication system in which at least one terminal and one mobile communication terminal device connected via radio are connected to each other over a network, said communication method comprising:
causing said one terminal to transmit position information transmit request mail to a special address provided in said mobile communication terminal device exclusively to accept a position information transmit request;
causing said mobile communication terminal device to receive said position information transmit request mail via said special address;
causing said mobile communication terminal device to receive GPS information from a GPS satellite in response to said received position information transmit request mail;
causing said mobile communication terminal device to acquire current position information based on said received GPS information;
causing said mobile communication terminal device to transmit said acquired position information as return mail to a predesignated mail address; and
causing said one terminal to receive said return mail.
